(19) United States
(12) Patent Application Publication
(10) Pub. No.: US 2008/0061037 A1
(43) Pub. Date: Mar. 13, 2008

(54) COMPOSITE ARC SUPPRESSION DEVICE

(76) Inventors: Thangavelu Asokan, Bangalore (IN); Sunil Srinivasa Murthy, Bangalore (IN); Patricia Chapman Irwin, Altamont, NY (US); Kunal Ravindra Coray, Bangalore (IN); Adnan Kutubuddin Bohori, Tavarekere (IN); Hari Nadathur Seshadri, Bangalore (IN)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 11/470,668

(22) Filed: Sep. 7, 2006

(51) Int. Cl. H01H 33/88

(52) U.S. Cl. 218/57

(57) ABSTRACT

An ablative arc suppression device (10) includes a first region (16) having a first electrical arc ablation characteristic and a second region (18) having a second electrical arc ablation characteristic. The first region and the second region are configured for defining an opening (22) extending through the first region and the second region for confining an arc initiation region (24) of an electrical arc (26) to be generated within the opening. The first region and the second region are further configured for defining the opening so that the electrical arc is exposed to both the first region and the second region before exiting the opening.

### FIELD OF THE INVENTION

Embodiments of the present invention are generally related to arc suppression devices, and, more particularly, to a composite ablative arc suppression device.

### BACKGROUND OF THE INVENTION

A variety of devices are known for interrupting current between a source and a load. Circuit breakers are one type of device designed to trip upon occurrence of heating or over-current conditions. In general, such devices include one or more moveable contacts, which separate from mating contacts to interrupt a current carrying path. The devices may be single phase or include multiple phase sections for interrupting current through parallel current paths, such as in three phase applications.

Performance of a circuit interrupter is typically dictated by a peak let through current, which is in turn controlled by a rate of arc voltage development across the contacts as the contacts are moved away from one another during a circuit interruption event. Accordingly, circuit interrupter performance has focused on more rapidly increasing arc voltage development to limit a peak let through current. One technique used to limit the let-through energy is to provide arc dissipating structures, such as conductive plates arranged with air gaps between each plate, commonly known as arc chutes. Entry of the arc into such structures may assist in extinguishing the arc and thereby limit the let-through energy during circuit interruption. Another arc dissipating technique includes the use of ablative materials disposed proximate the contacts of the circuit interrupter. During an arcing event, some of the ablative material is vaporized by the arc. The resulting ablation vapors interact with the arc to absorb the arcing energy, resulting in lower arc temperatures and dissipation of the arc.

### BRIEF DESCRIPTION OF THE INVENTION

In an example embodiment, the invention includes an ablative arc suppression device. The ablative arc suppression device includes a first region having a first electrical arc ablation characteristic and a second region having a second electrical arc ablation characteristic. The first region and the second region are configured for defining an opening extending through the first region and the second region for confining an arc initiation region of an electrical arc to be generated within the opening. The first region and the second region are further configured for defining the opening so that the electrical arc is exposed to both the first region and the second region before exiting the opening.

In another example embodiment, the invention includes an ablative arc suppression device having a first region, a second region overlying the first region, and a third region underlying the first region. The second and third regions comprise electrical arc ablation characteristics different than an electrical arc ablation characteristic of the first region. The regions are configured for defining an opening extending through the regions for confining an arc initiation region of an electrical arc to be generated within the opening, wherein the regions are further configured for defining the opening so that the electrical arc is exposed to each region before exiting the opening.

In another example embodiment, the invention includes an arc suppressing switch device including an ablative arc suppression device having a first region overlying the first region, wherein the first region and the second region are configured for defining an opening extending through the first region and the second region for confining an arc initiation region of an electrical arc to be generated within the opening, and wherein the first region and the second region are further configured for defining the opening so that the electrical arc is exposed to both the first region and the second region before exiting the opening. The arc suppressing switch device also includes a pair of separable electrical contacts disposed within the opening when positioned in contact with each other and generating the electrical arc therein upon being separated.

In another example embodiment, the invention includes an ablative arc suppression device having a plurality of regions configured for defining an opening extending through the regions for confining an arc initiation region of an electrical arc to be generated within the opening. The regions are further configured for defining the opening so that the electrical arc is exposed to each of the regions before exiting the opening. A least two of the plurality of regions comprise different electrical arc ablation characteristics.

### BRIEF DESCRIPTION OF THE DRAWINGS

FIG. 1 shows a cross sectional schematic view of an example embodiment of an ablative arc suppression device having axial type electrical contacts disposed in an opening of the device.

FIG. 2 shows a cross sectional schematic view of the example embodiment of the ablative arc suppression device of FIG. 1 with one of the contacts partially withdrawn from the opening.

FIG. 3 shows a cross sectional schematic view of the example embodiment of the circuit interrupter of FIG. 1 with one of the contacts withdrawn from the opening.

FIG. 4 shows another example embodiment of an ablative arc suppression device.

FIG. 5 shows another example embodiment of an encapsulated ablative arc suppression device.

FIG. 6 shows another example embodiment of an ablative arc suppression device having a variably contoured opening.

FIG. 7 shows another example embodiment of an ablative arc suppression device comprising a plurality of different regions and a variably contoured opening.

FIG. 8 shows a perspective view of the ablative arc suppression device of FIG. 1

FIG. 9 shows a cross sectional schematic view of another example embodiment of an ablative arc suppression device having blade type electrical contacts disposed in an opening of the device.

FIG. 10 shows a perspective view of the ablative arc suppression device of FIG. 1

FIG. 11 shows a cut away perspective view of the ablative arc suppression device of FIG. 6.

### DETAILED DESCRIPTION OF THE INVENTION

The inventors of the present invention have innovatively recognized that it may be advantageous for an ablative material for use in an arc suppressing device to possess a desired arc energy absorption characteristic while providing a desired reduced ablation vapor pressure around the arc. For example, it has been experimentally observed that high vapor pressures, such as vapor pressures above 100 bars, resulting from ablation in a confined region, may limit arc cooling, resulting in undesirably longer arc extinguishing times. Such elevated vapor pressure may result from a choked exhaust flow condition wherein ablation vapors may not be evacuated from the confined region, resulting in the ablation vapors receiving more arc energy causing increased temperature and reduced arc quenching performance. Accordingly, the inventors have developed a composite arc suppression device that includes different regions providing different ablation characteristics to achieve desired arc energy absorption while providing reduced vapor pressure for continued suppression of the arc.

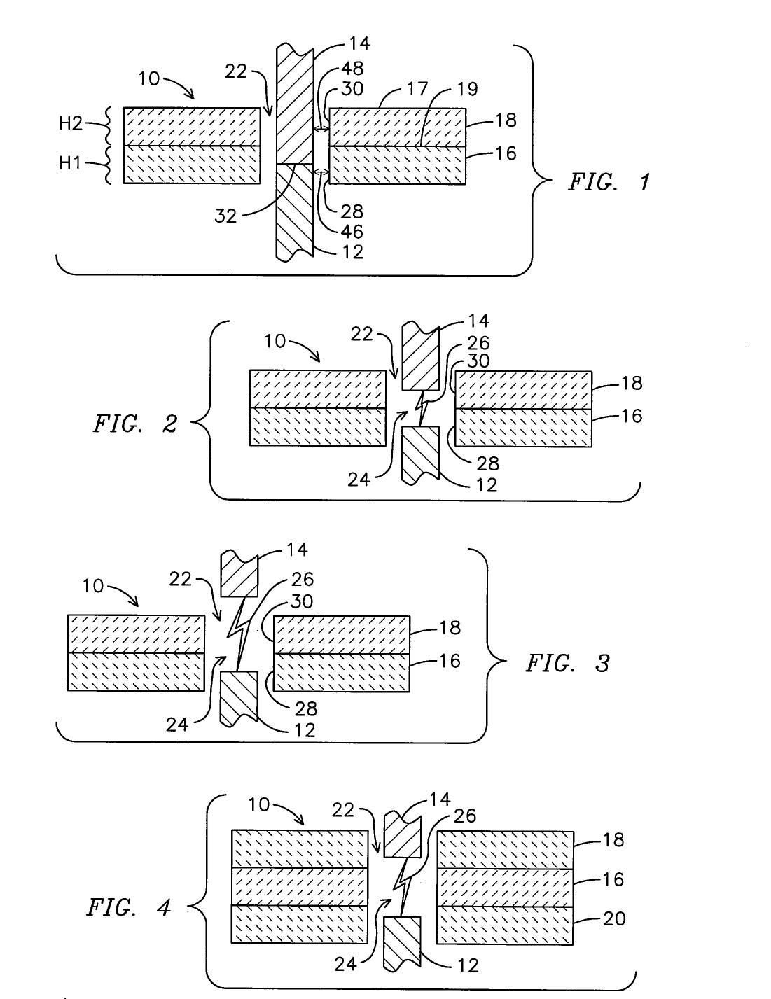

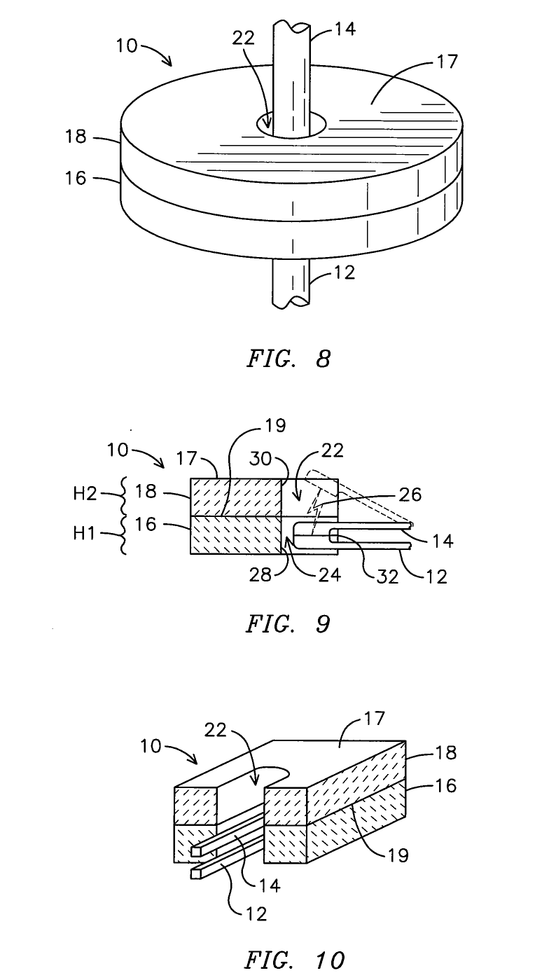

FIG. 1 shows a cross sectional schematic view of an example embodiment of an ablative arc suppression device 10 having a pair of separable electrical contacts 12, 14, disposed within an opening 22 of the device 10. FIG. 8 shows a perspective view of the example embodiment of FIG. 1 wherein the ablative arc suppression device 10 is configured as a disk. Although axial type contacts are depicted in FIGS. 1 and 8, other types of contacts, such as blade type contacts, may be used. For example, FIGS. 9 and 10 show an example embodiment of an ablative arc suppression device 10 having a pair of separable blade type electrical contacts 12, 14 disposed within the opening 22. As shown in FIG. 10, the ablative arc suppression device 10 may be configured in a U-shape.

The ablative arc suppression device 10 may include a first region 16 having a first electrical arc ablation characteristic and a second region 18 having a second electrical arc ablation characteristic different than the first region 16. The first region 16 and the second region 18 may be to define the opening 22 that extends through the first region 16 and the second region 18. In an aspect of the invention, the opening 22 may be configured to extend through the first region 16 and the second region 18 perpendicularly with respect to respective region boundary surfaces 17, 19. As shown in FIG. 2 and FIG. 9, the opening 22 may be configured for confining an arc initiation region 24 of an electrical arc 26 generated within the opening 22, such as an electrical arc generated between contacts 12, 14 when the contacts 12, 14 are separated to interrupt an electrical current flowing through the contacts 12, 14. For example, one, or both, of the contacts 12, 14 may be movable out of electrical contact with the other to interrupt the electrical current as shown in FIG. 2 and FIG. 9, contact 14′ indicated with dotted lines. In an embodiment, the contacts 12, 14 may comprise a switch, such as switch of the type used in a circuit interrupter or circuit breaker. Accordingly, an arc suppression switch device may include the ablative arc suppression device 10 with contacts 12, 14 such as axial or blade type contacts, moveably disposed in the opening 22.

The first region 16 and the second region 18 may be further configured for defining the opening 22 so that the electrical arc 26 generated therein is exposed to both the first region 16 and the second region 18 before the arc 26 exits the opening 22 as shown in FIG. 3. For example, the regions 16, 18 may include respective surface portions 28, 30 configured for sequential exposure to the arc 26 as it grows away from an arc initiation region 24. For example, as depicted in FIG. 1, the surface portion 28 of the first region 16 may be configured for being disposed around the closed contacts 12, 14 proximate a contacting point 32 of the contacts 12, 14 so that the first region 16 is first exposed to the arc 26 when arcing is initiated. In an example embodiment, the contacting point 32 may be disposed so that it is centered with respect to the first region 16. As shown in FIG. 2 and FIG. 9, the surface portion 30 of the second region 18 may be configured for being exposed to the lengthening arc 26 after the arc 26 has been exposed to the surface portion 28 of the first region 16.

In an aspect of the invention, the regions 16, 18 may be configured to have different arc reactive properties, for example, to achieve a desired arc quenching effect, such as to initially provide relatively high ablation, and later, as the arc 26 lengthens, to provide a relatively low ablation to limit a pressure increase in the opening 22 due to a build up of ablation vapors. For example, the first region 16 may comprise a material having a comparatively higher ablative vapor generation characteristic than the second region 18. Accordingly, upon initiation of an arc 26 within the opening 22, the arc 26 contacts the first region 16 and generates a relatively large volume of ablation vapors. The ablation vapors interact with the arc 26 and absorb the energy in the arc 26, resulting in a lower arc temperature and help to quench the arc 26. However, it has been observed by the inventors that a large ablation vapor volume generated within the opening 22 may adversely affect further arc quenching due to an ablation vapor-induced pressure build up within the opening 22, for example, due to a choked exhaust flow condition, for example, limiting exhaust of vapors from the arc confinement region 24 of the opening 22. When the opening 22 is configured to confine the arc 26 therein, such as by limiting a spacing 46, 48 of the surface portions 28, 30 of the opening 22 away from the contacts 12, 14, the inventors have experimentally determined that it is desired to keep the vapor pressure in the opening 22 under about 100 bars to achieve sufficient arc quenching. Accordingly, as the arc lengthens within the opening 22 and is exposed to the second region 18 having a comparatively lower ablative vapor generation characteristic, the arc 26 generates a reduced volume of ablation vapors compared to the volume produce when exposed to the first region 18. Consequently, pressure build up within the opening 22 is reduced compared to a case where the arc 26 is only exposed to the first region 16 having a comparatively higher ablative vapor generation characteristic as it lengthens, allowing arc quenching to proceed with less interference from an ablation vapor-induced pressure rise. In an aspect of the invention, the heights H1, H2 of the respective regions 16, 18 may be sized to achieve desired respective ablation and pressure reducing characteristics. For example, the first region 16 may be configured to have a height of between about 2 millimeters (mm) to about 5 mm for use with axial type contacts as shown in FIG. 2 and blade type contacts shown in FIG. 9. In an example embodiment, the first region may be centered around contacting point 32 of the contacts 12, 14. For example, contacting point 32 may be disposed at a location about half of height H1 in region 16.

For an ablative arc suppression device 10 accommodating axial type contacts as depicted in FIGS. 1-3, and 8, the opening 22 may include a cylindrical shape conforming to a shape of the axial type contacts disposed therein. For an ablative arc suppression device 10 accommodating blade type contacts as depicted in FIGS. 9 and 10, the opening 22 may include a u-shape conforming to a shape of the blade type contacts 12, 14 disposed therein. In another example embodiment depicted in FIG. 6, the opening 22 may comprise a variably contoured shape, such that an opening portion 13 defined by the first region 15 defines a smaller opening portion volume 29 than an opening portion volume 29 of an opening portion 15 defined by the second region 18.

A method for determining an effectiveness of an ablative for use in arc quenching may include first determining a heat of vaporization of a desired ablative material. Determining a heat of vaporization may include using a differential thermal analysis. An ablation rate may then be calculated using the determined heat of vaporization. Next, energy required for disassociation of molecules of the ablative and ionization of atoms and molecules of the ablative may be derived, for example, using a Specific Heat (Cp) versus temperature (T) curve, such as may be found in IEEE Transactions on Plasma Science, Vol. PS-12, No. 1, pp 38-42, March 1984, for the material in the temperature range of 5,000 to 24,000 Kelvin. A total dissipated energy for the ablative may be calculated as the product of the cumulative energies, for example, up to 24,000 Kelvin and an ablated mass. It has been determined by the inventors that ablation characteristics of an ablative material may be attributed to high energy absorption capabilities of the material that are primarily dictated by the material's hydrogen content. It has been further determined by the inventors that such ablative materials may be classified based on a product of enthalpy and ablative volume. The above method may be used, for example, in determining desired materials to be used in the above described arc suppression device 10.

Ablative materials such as polyoxymethylene, polymethylpentene, poly-methylacrylate, poly-amide, poly-butylene teraphthalate, polyester, and phenolic composite have been found to possess desired ablative characteristics for use in arc quenching. In particular, polymers such as DELRIN®, manufactured by E.I. du Pont de Nemours and Company, USA, and a phenolic composite known in the trade as HYLAM manufactured by Bakelite Hylam Limited, India, have been demonstrated to have desired ablation characteristics. For example, DELRIN® has a relatively higher energy absorption characteristic than HYLAM, thereby providing higher volume ablation suitable for arc quenching. Conversely, HYLAM has a relatively lower energy absorption characteristic than DELRIN®, thereby providing lower volume ablation than DELRIN® suitable for pressure reduction when used in associated with DELRIN®. For example, to achieve a desired level of arc cooling by the arc suppression device, the first region 16 may include a polymer material having a desired higher ablation characteristic, such as DELRIN® to achieve a desired high energy dissipation effect, and the second region 18 may include a phenolic composite having a desired lower ablation characteristic, such as HYLAM, to achieve a desired pressure controlling effect. Alternatively, the first region 16 may include a material having a relatively lower ablation characteristic, and the second region 18 may include may include a material having a relatively higher ablation characteristic.

In another example embodiment depicted in FIG. 4, the arc suppression device may include a third region 20, for example, underlying the first region 16, configured for further defining the opening 22. Accordingly, the ablative arc suppression device 10 may include first, second, and third regions 16, 18, 20 arranged so that the second region 18 and the third region 20 are separated by the first region 16. The regions 16, 18, 20 may be configured for defining the opening 22 extending through the regions 16, 18, 20 so that the electrical arc 26 formed therein by separating contacts 12, 14 is exposed to each region 16, 18, 20 before exiting the opening 22. In an aspect of the invention, the opening 22 may be configured to extend perpendicularly through the regions 16, 18, 20.

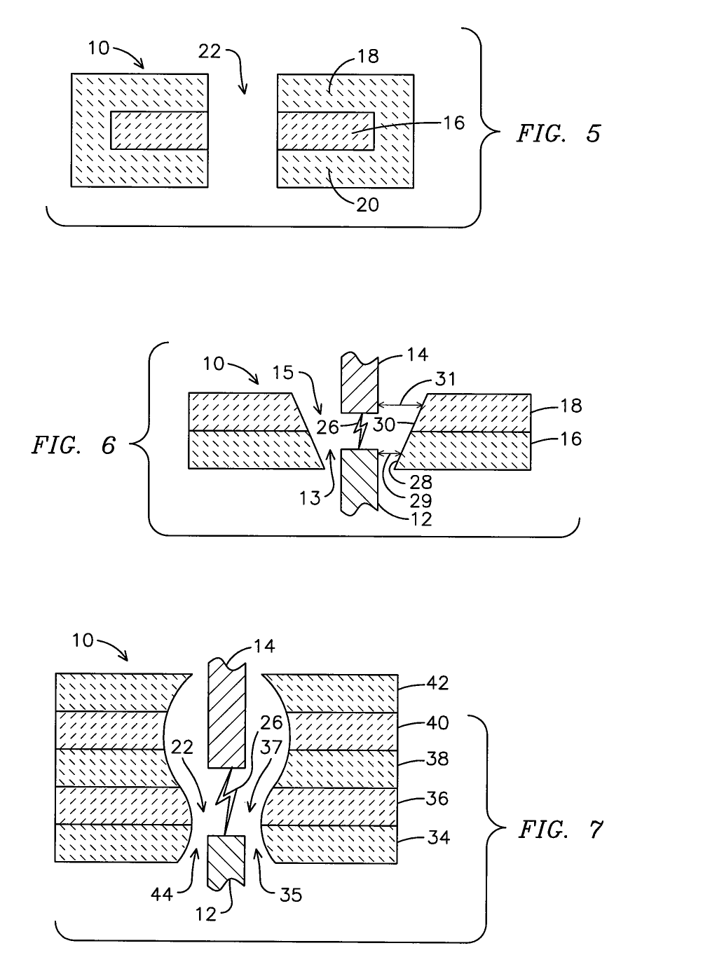

The second region 18 and third region 20 may include an electrical arc ablation characteristic different than an electrical arc ablation characteristic of the first region 16. For example, the second region 18 and third region 20 may comprise comparatively lower ablative vapor generation characteristics than the first region 16. In such an embodiment, the arc suppression device 10 may include a HYLAM-DELRIN®-HYLAM sandwich. In another example embodiment, the second region 18 and third region 20 may comprise comparatively higher ablative vapor generation characteristics than the first region 16. In such an embodiment the arc suppression device 10 may include a DELRIN®-HYLAM-DELRIN® sandwich. In yet another embodiment, the second region 18 and third region 20 may comprise a thermo-set, composite, ceramic, or inorganic material. Such materials may be used to encapsulate the first region 16, except at the opening 22, as depicted in FIG. 5.

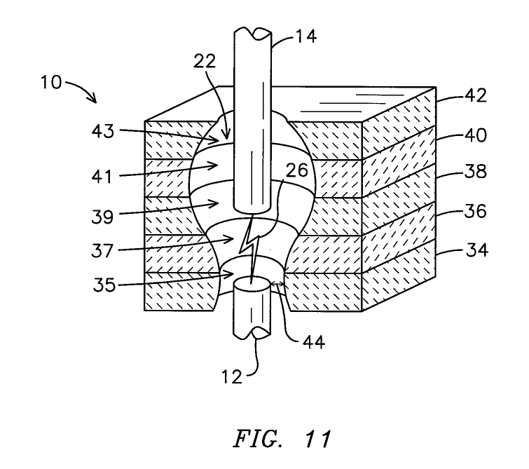

In another example embodiment depicted in FIG. 7 and FIG. 11, the arc suppression device 10 may include a plurality of regions 34, 36, 38, 40, 42 configured for defining an opening 22 extending through the regions 34, 36, 38, 40, 42, wherein at least two of the plurality of regions 34, 36, 38, 40, 42 comprise different electrical arc ablation characteristics. For example, region 34 and region 36 may comprise different electrical arc ablative characteristics such that first region 34 comprises a comparatively higher ablative vapor generation characteristic than an ablation characteristic of region 36. In the example embodiment depicted in FIG. 7 and FIG. 11, the opening 22 may comprise a variably contoured shape, such that at least one of the regions defines a relatively smaller opening portion volume than opening portion volumes defined by the other regions. For example, an opening portion volume 35 defined by region 34 may define a smaller opening portion volume than opening portion volumes 37, 39, 41, 43 defined by regions 36, 38, 40, 42. Accordingly, the smaller opening volume portion 35 defined by region 34 may constrict a space 44 around contact 12 so that an arc 26 initiated between contacts 12 and 14 is relatively close to region 34 for interacting with the region 34 to quickly form ablation vapors. A relatively larger opening volume 37 defined by region 36 may provide a larger space for allowing ablation vapors to expand to cool the arc 26.

While certain embodiments of the present invention have been shown and described herein, such embodiments are provided by way of example only. Numerous variations, changes and substitutions will occur to those of skill in the art without departing from the invention herein. Accordingly, it is intended that the invention be limited only by the spirit and scope of the appended claims.

What is claimed is:

1. An ablative arc suppression device comprising:
a first region having a first electrical arc ablation characteristic; and
a second region having a second electrical arc ablation characteristic, wherein the first region and the second region are configured for defining an opening extending through the first region and the second region for confining an arc initiation region of an electrical arc to be generated within the opening, wherein the first region and the second region are further configured for defining the opening so that the electrical arc is exposed to both the first region and the second region before exiting the opening.

2. The arc suppression device of claim 1, wherein the first electrical arc ablation characteristic comprises a comparatively higher ablative vapor generation characteristic than the second electrical arc ablation characteristic.

3. The arc suppression device of claim 1, wherein the first electrical arc ablation characteristic comprises a comparatively lower ablative vapor generation characteristic than the second electrical arc ablation characteristic.

4. The arc suppression device of claim 1, wherein the first region comprises a polymer.

5. The arc suppression device of claim 1, wherein the first region comprises at least one of polyoxymethylene, polymethylpentene, poly-methylacrylate, poly-amide, poly-butylene teraphthalate, and polyester.

6. The arc suppression device of claim 1, wherein the second region comprises at least one of a thermoset material, a composite material, a ceramic material, and an inorganic material.

7. The arc suppression device of claim 1, further comprising a third region configured for further defining the opening.

8. The arc suppression device of claim 7, wherein the third region is separated from the second region by the first region.

9. The arc suppression device of claim 7, wherein the third region comprises the same electrical arc ablation characteristic as the second electrical arc ablation characteristic.

10. The arc suppression device of claim 1, wherein the opening extends through the first region and the second region perpendicularly with respect to respective boundary surfaces of the first region and the second region.

11. The arc suppression device of claim 1, wherein the first region comprises a height from about 2 millimeters to about 5 millimeters at the opening.

12. The arc suppression device of claim 1, wherein the opening comprises a cylindrical shape.

13. The arc suppression device of claim 1, wherein the opening comprises a variably contoured shape.

14. The arc suppression device of claim 13, wherein the first region defines a relatively larger opening portion volume than an opening portion volume defined by the second region.

15. An ablative arc suppression device, comprising:
a first region;
a second region overlying the first region; and
a third region underlying the first region, the second and third regions comprising electrical arc ablation characteristics different than an electrical arc ablation characteristic of the first region; wherein the regions are configured for defining an opening extending through the regions for confining an arc initiation region of an electrical arc to be generated within the opening, wherein the regions are further configured for defining the opening so that the electrical arc is exposed to each region before exiting the opening.

16. An arc suppressing switch device comprising:
an ablative arc suppression device having a first region overlying the first region, wherein the first region and the second region are configured for defining an opening extending through the first region and the second region for confining an arc initiation region of an electrical arc to be generated within the opening, wherein the first region and the second region are further configured for defining the opening so that the electrical arc is exposed to both the first region and the second region before exiting the opening; and
a pair of separable electrical contacts disposed within the opening when positioned in contact with each other and generating the electrical arc therein upon being separated.

17. The arc suppressing switch device of claim 16, wherein the electrical contacts are disposed adjacent to the first region when positioned in contact with each other.

18. The arc suppression device of claim 17, wherein the first region is centered around a contact point of the contacts when positioned in contact with each other.

19. The arc suppression switch device of claim 16, wherein the first region comprises a comparatively higher ablative vapor generation characteristic than an electrical arc ablation characteristic of the second region.

20. The arc suppression switch device of claim 16, wherein the first region comprises a comparatively lower ablative vapor generation characteristic than an electrical arc ablation characteristic of the second region.

21. The arc suppression switch device of claim 16, further comprising a third region separated from the second region by the first region.

22. The arc suppression switch device of claim 21, wherein the third region comprises the same electrical arc ablation characteristic as the second region.

23. An ablative arc suppression device comprising a plurality of regions configured for defining an opening extending through the regions for confining an arc initiation region of an electrical arc to be generated within the opening, wherein the regions are further configured for defining the opening so that the electrical arc is exposed to each of the regions before exiting the opening, wherein at least two of the plurality of regions comprise different electrical arc ablation characteristics.

24. The arc suppression device of claim 23, wherein the opening extends through the regions perpendicularly with respect to a boundary surface of at least one of the regions.

25. The arc suppression device of claim 23, wherein the opening comprises a cylindrical shape.

26. The arc suppression device of claim 23, wherein the opening comprises a variably contoured shape.

27. The arc suppression device of claim 26, wherein at least one of the regions defines a relatively smaller opening portion volume than an opening portion volume defined by a different region.
